(19) United States
(12) Patent Application Publication
(10) Pub. No.: US 2022/0327378 A1
(43) Pub. Date: Oct. 13, 2022

(54) METHOD AND SYSTEM FOR CLASSIFYING ENTITY OBJECTS OF ENTITIES BASED ON ATTRIBUTES OF THE ENTITY OBJECTS USING MACHINE LEARNING

(71) Applicant: Clari Inc., Sunnyvale, CA (US)

(72) Inventors: Venkat RANGAN, Sunnyvale, CA (US); Will PATTERSON, Sunnyvale, CA (US)

(21) Appl. No.: 17/229,568

(22) Filed: Apr. 13, 2021

(51) Int. Cl. G06N 3/08; G06N 3/04; G06F 16/28; G06F 16/2457

(52) U.S. Cl. CPC G06N 3/08; G06N 3/0454; G06N 3/0472; G06F 16/288; G06F 16/24578

(57) ABSTRACT

Described herein are systems and methods for classifying entities based on their respective attributes using machine learning. In one embodiment, a method of classifying target entities includes retrieving private data and public data for entities; extracting features from the public data and the private data; providing the features to a machine learning model that includes a first submodel, and a second submodel, the first submodel outputting a potential entity value for each entity, and the second machine learning model outputting a likelihood of performing a predetermined action for each entity, generating an entity score; ranking the entities based on the entity scores of the entities; and selecting a predetermined number of top ranked entities.

### TECHNICAL FIELD

Embodiments of the present invention relate generally to machine learning. More particularly, embodiments of the invention are related to using machine learning models to classify entities.

### BACKGROUND

One of the fundamental challenges is to determine the future behavior or actions an entity or a user group likely to perform. As the Internet has been widely utilized, one can obtain publicly available information of an entity or user group to guess whether the entity or user group will likely perform certain actions. However, such determination is not accurate without taking into an account of private data of the entity or user group.

### BRIEF DESCRIPTION OF THE DRAWINGS

Embodiments of the invention are illustrated by way of example and not limited to the figures of the accompanying drawings in which like references indicate similar elements.

FIG. 1 illustrates a system for identifying target entities for a source entity in accordance with an embodiment.

FIGS. 2A-2B further illustrate the entity management UI according to one embodiment.

FIG. 3 illustrates input data provided to an entity prioritization machine learning model according to one embodiment.

FIG. 4 illustrates an example of a machine learning model for generating predicted entity values according to one embodiment.

FIG. 5 further illustrates the submodel for estimating the likelihood of performing a specific action from a particular entity according to one embodiment.

FIGS. 6A-6C illustrate a cosine similarity algorithm according to one embodiment.

FIGS. 6D-6F illustrates different ways of computing the cosine similarity scores for each new entity according to one embodiment.

FIG. 7 is a flow diagram illustrating an example of a process of identifying target entities according to one embodiment.

FIG. 8 further illustrates the data hub according to one embodiment.

FIG. 9 illustrates an entity object according to one embodiment.

FIG. 10 is a block diagram illustrating an example of a data processing system which may be used with one or more embodiments of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” or “in an embodiment” in various places in the specification do not necessarily all refer to the same embodiment.

According to various embodiments, described herein are systems and methods for classifying entities based on features extracted from different types data associated with the entities. The method may be performed by processing logic hosted by a cloud server or a cluster of cloud servers, where the processing logic may include software, hardware, or a combination thereof. In one embodiment, a method of ranking entity objects is provided. A cloud server receives over a network a request from a client device associated with a source entity for ranking target entities that are related to the source entity. Each of the source entity and target entities is associated with a user group. In response to the request, processing logic accesses a task database system via a first application programming interface (API) to identify a list of target entity objects corresponding to the target entities.

For each of the target entity objects, according to one embodiment, processing logic accesses a data source via a second API to retrieve a first set of metadata associated with the target entity object. The first set of metadata includes information describing the target entity perceived from other entities and generated by the data source. A second set of metadata is retrieved from the task database system via the first API. The second set of metadata includes information describing one or more tasks collaboratively performed between the source entity and the target entity. A first set of features is extracted from the first set of metadata and a second set of features is extracted from the second set of metadata. Processing logic then applies a machine-learning (ML) model to the first set of features and the second set of features to generate an entity score for the target entity. The entity score represents a degree of relevancy between the source entity and the target entity. In one embodiment, the processing logic further ranks the target entities based on their respective entity scores. The ranking information of at least a portion of the ranked target entities is transmitted to the client device over the network.

In one embodiment, applying the ML model to the first and second sets of features includes applying a first neural network (e.g., first ML submodel) to the first and second sets of features to determine a first score representing a degree of how valuable of the target entity perceived by the source entity, wherein the entity score is determined based on the first score. In another embodiment, applying the ML model further includes applying a second neural network (e.g., second submodel) to the first and second sets of features to determine a second score representing a likelihood the target entity will perform a task collaboratively with the source entity within a predetermined time period. Processing logic then generates the entity score for the target entity based on the first score and the second score using a predetermined algorithm.

In one embodiment, processing logic selects a predetermined number of top-ranked target entities based on their respective entity scores, and transmits the ranking information of the top-ranked entities to the client device to be displayed in a graphical user interface (GUI) of the client device. The data source includes at least one of a public firmographic database, a popularity ranking database, or a user satisfaction ranking database.

In one embodiment, the first set of metadata of a target entity includes at least one of a number of users within a corresponding user group of the target entity, resources used by the user group, or interactions with other entities. The second set of metadata of a target entity includes at least one of one or more prior tasks completed between the source entity and the target entity, types of the tasks completed, or subsequent activities of the prior completed tasks performed between the source entity and the target entity.

In one embodiment, the second neural network uses one or more ML algorithms, including a market basket analysis, a term frequency-inverse document frequency (TFIDF) representation, cosine similarity, decision tree, random forest, or a gradient boosting. The entity score is calculated based on a product of the first score and the second score.

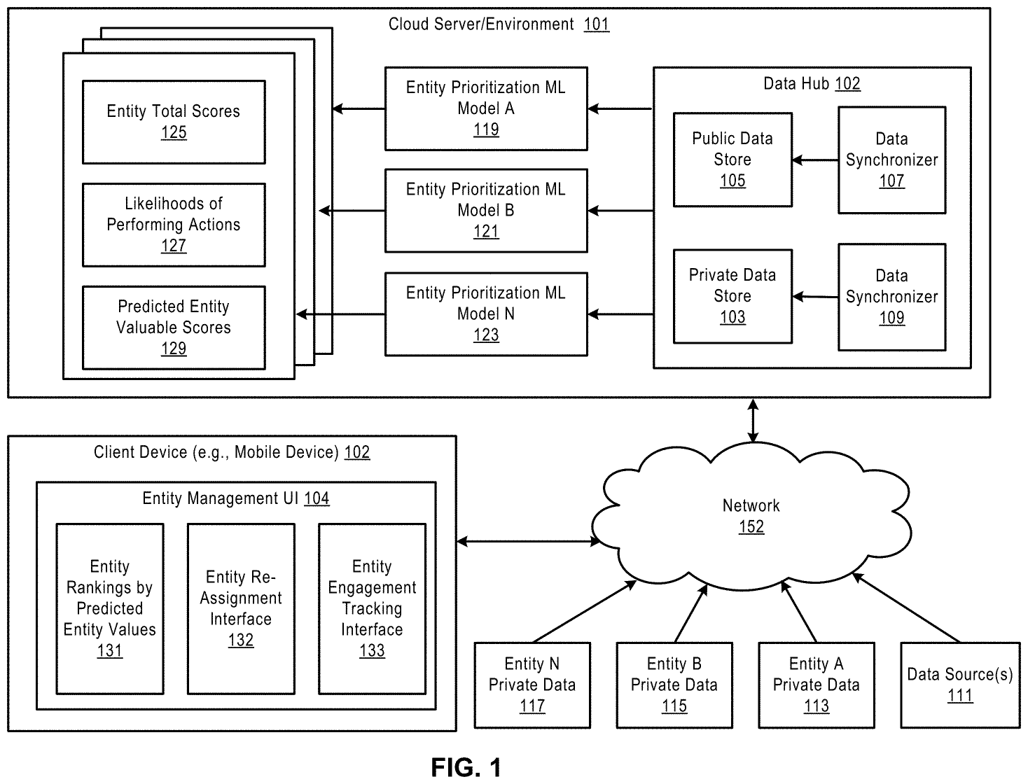

FIG. 1 illustrates a system for identifying target entity for a source entity in accordance with an embodiment. In FIG. 1, a cloud server/environment 101 includes a data hub 102, which interacts with application programming interfaces (APIs) to extract data over a network 152 from a variety of data sources, such as private data sources 113, 115 and 117, and a public data source(s) 111 (e.g., firmographic database systems). Cloud server 101 may be a data analytics server or a cluster of data analytics servers for analyzing data provided from data sources 111, 113, 115, and 117. Network 152 can be any type of networks such as a local area network (LAN), a wide area network (WAN) such as the Internet, or a combination thereof, wired or wireless. The extracted data can be stored in the data hub 102 in data stores 103 and 105. The data store 103 can store private data of entities, and the data store 105 can store public data (e.g., firmographic information) of the entity.

In one embodiment, the data hub 102 can include one or more extractors, one or more data loaders and one or more query management components. Further, the data hub 102 can include a data synchronizer 107 for periodically synchronizing the public data stored in the data store 105 with the public firmographic data vendor 111; and a data synchronizer 109 for periodically synchronizing the private data stored in the data store 103 with the private data sources 113, 115 and 117. The data obtained from various data sources is associated with entities. Such data is also referred to as metadata or attributes of the entities, i.e., the data describing the entities. These components may perform independently and/or in parallel via different execution threads.

The public firmographic data vendor 111 can provide information that describes and quantifies the characteristics of entities, including the size of each entity, the industries, fields, or communities that entity belongs to, the status or state of the entity, the value of the entity, and the processing cycle length of the company. An example of such a public firmographic data vendor is DUN & BRADSTREET®. An entity described throughout this application can represent a user group, an organization, or a unit or department of an organization, etc.

The private data sources 113, 115 and 117 can be task database systems that provide internal data of the entities, such as time-series transaction or activity data, which can be data stores, tables, or databases in a task database system. The task database system may store information related to the tasks performed or will be performed by various entities. The task database system may be hosted by a third-party organization that is independent from the organization operating the cloud server 101. The private data can include any kinds of task management data, e.g., data related to tasks and documents associated with the tasks. The task database system can compile information on it clients (e.g., source and/or target entities) across different channels or points of contact between a source entity and a target entity that uses the task database system. Examples of channels include the entity's website, telephone, live chat, direct mail, and social media, etc. A source entity referred to herein is an entity that provides services or goods to a target entity, i.e., having an existing relationship with the target entity. The metadata describing the relationship between a source entity and a target entity may be stored in the task database system and/or private store 103.

In one embodiment, the cloud server/environment 101 further includes a trained machine learning model for each entity that has created an entity or user account with the cloud environment 101. The user account allows a source entity to upload its private data using the data hub 102 to the cloud environment 101, and to have a machine learning model trained and deployed for the source entity to classify the target entities associated with the source entity. Alternatively, the cloud server 101 can retrieve such private data from the corresponding task database system via an API over a network.

As shown in FIG. 1, the cloud environment 101 includes an entity prioritization machine learning (ML) model A 119 for source entity A, an entity prioritization ML model B for source entity B 121, and an entity prioritization ML model N for source entity N 123. Although three source entities are shown, more source entities can be applicable. Each ML model can be trained using the entity-specific private data stored in the private data store 103 and the public data such as firmographic data relevant to the entity stored in the public data store 105. Alternatively, an ML model can be trained using data associated with multiple entities. The ML models 119, 121, and 123 can run on one or more servers in the cloud environment 101. Each of the cloud servers can be any kind of servers or a cluster of servers, such as, for example, Web servers, application servers, cloud servers, backend servers, etc.

In one embodiment, each ML model, when triggered, can classify and generate a list of entities (e.g., target entities) that are likely to perform a specific action or task collaboratively with a source entity. The number of entities in the list can be predetermined and dynamically configured for each source entity. The target entities can then be ranked from based on their predicted account values outputted by the ML model trained for the source entity.

In one embodiment, when cloud server receives 101 over network 152 a request from a client device 102 associated with a source entity (e.g., source entities A, B, or N) for ranking target entities that are related to the source entity. Each of the source entity and target entities is associated with a user group. In response to the request, a task database system is accessed via a first API to identify a list of target entity objects corresponding to the target entities. For example, for source entity A, the corresponding task database system such as private data source 113 is accessed to identify a list of target entities associated with source entity A. The identified target entities have an existing relationship with the source entity (e.g., performing a task collaboratively or have a prior transaction between them).

For each of the target entity objects, according to one embodiment, a data source (e.g., public data store 106) is accessed via a second API to retrieve a first set of metadata associated with the target entity object. The first set of metadata includes information describing the target entity perceived from other entities and generated by the data source. A second set of metadata is retrieved from the task database system (e.g., data source 113) via the first API. The second set of metadata includes information describing one or more tasks collaboratively performed between the source entity and the target entity. A first set of features is extracted by a feature extractor (not shown) from the first set of metadata and a second set of features is extracted from the second set of metadata. A machine-learning (ML) model, such as model 119, is applied to the first set of features and the second set of features to generate an entity score for the target entity. The entity score represents a degree of relevancy between the source entity and the target entity. In one embodiment, a ranking module (not shown) ranks the target entities based on their respective entity scores. The ranking information of at least a portion of the ranked target entities is transmitted to the client device 102 over the network 152.

In one embodiment, applying the ML model to the first and second sets of features includes applying a first neural network (e.g., first ML submodel) to the first and second sets of features to determine a first score representing a degree of how valuable of the target entity perceived by the source entity, referred to as predicted entity valuable score 129. In another embodiment, applying the ML model further includes applying a second neural network (e.g., second submodel) to the first and second sets of features to determine a second score representing a likelihood the target entity will perform a task collaboratively with the source entity within a predetermined time period, referred to as likelihood of performing actions 127. The total entity score 125 is generated for the target entity based on the first score and the second score using a predetermined algorithm.

In one embodiment, a predetermined number of top-ranked target entities is selected based on their respective entity scores, and the ranking information of the top-ranked entities is transmitted to the client device 102 to be displayed in a graphical user interface (GUI) 104 of the client device 102. The data source includes at least one of a public firmographic database, a popularity ranking database, or a user satisfaction ranking database.

In one embodiment, the first set of metadata of a target entity includes at least one of a number of users within a corresponding user group of the target entity, resources used by the user group (e.g., IT or R&D budget), or interactions with other entities. The second set of metadata of a target entity includes at least one of one or more prior tasks completed between the source entity and the target entity, types of the tasks completed, or subsequent activities of the prior completed tasks performed between the source entity and the target entity.

In one embodiment, the second neural network uses one or more ML algorithms, including a market basket analysis, a term frequency-inverse document frequency (TFIDF) representation, cosine similarity, decision tree, random forest, or a gradient boosting. The entity score is calculated based on a product of the first score and the second score.

In one embodiment, the list of ranked target entities 131 can be displayed in a graphical user interface, for example, an entity management UI 104, on a client device 102. The client device 102 can be any type of clients such as a host or server, a personal computer (e.g., desktops, laptops, and tablets), a “thin” client, a personal digital assistant (PDA), a Web enabled appliance, or a mobile phone (e.g., Smartphone), etc.

The entity management UI 104 can also include an interface 132 for assigning an entity with a certain predicted account value to a particular user of the source entity. The entity management UI 104 can further include an interface 133 for tracking entity engagement to ensure that the user assigned to an entity interacts with users of the corresponding target entity.

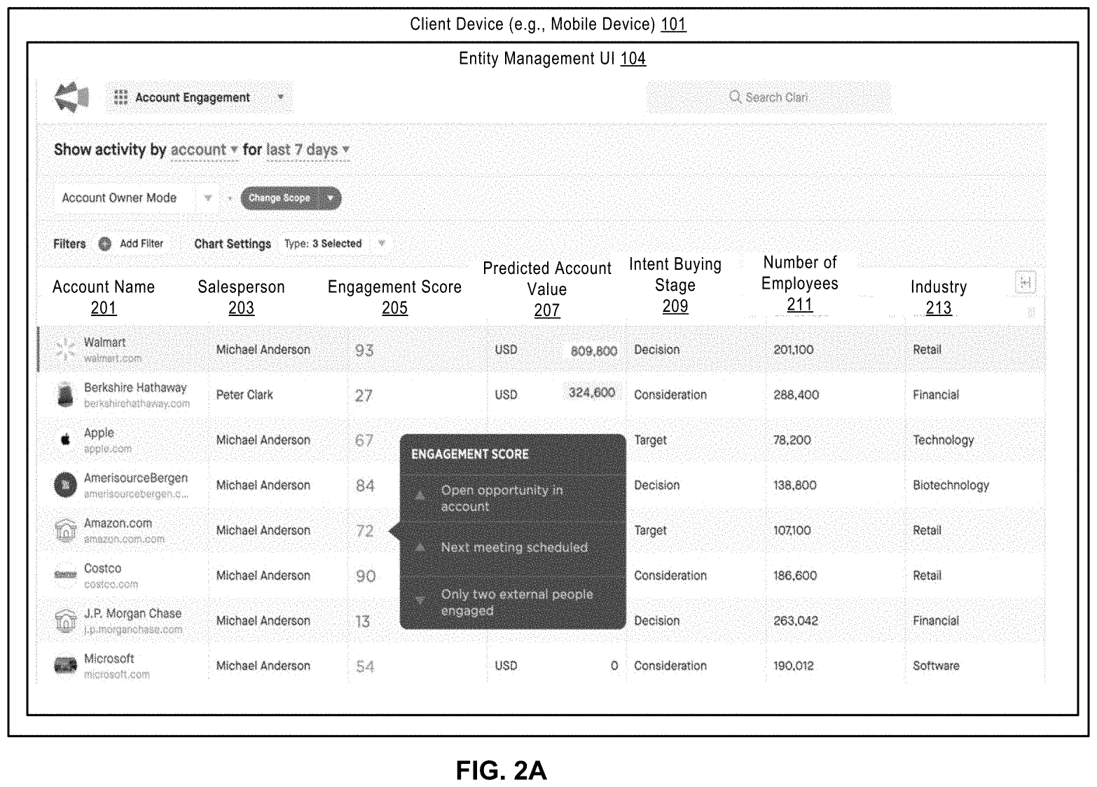

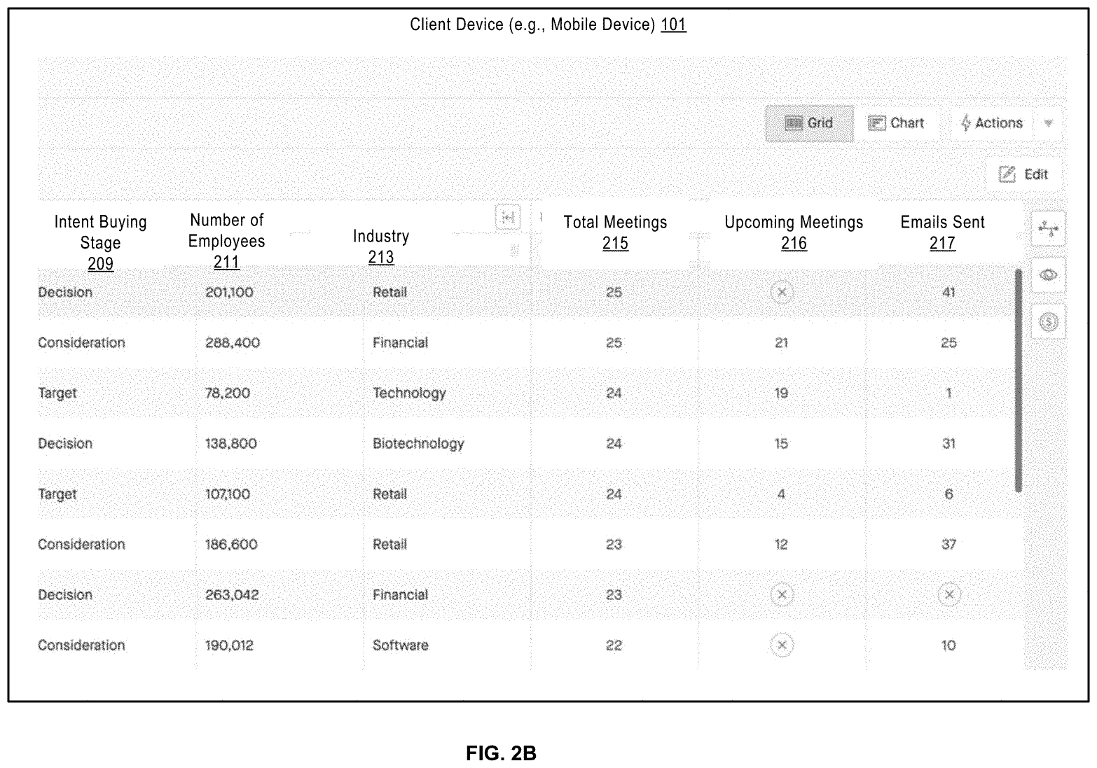

FIGS. 2A-2B further illustrate the entity management UI according to one embodiment. The entity management UI 104 can display a list of target entities for source entity A. These entities are ranked by their predicted entity values calculated by the entity prioritization ML model A 119 described in Figure A. A predicted entity value represents an amount of transactions that an entity is likely to interact with source entity A within a predetermined time period in the future.

In one embodiment, the entity management UI 104 can display an entity name or identifier 201 for each target entity, a user 203 assigned to that target entity, an engagement score 205 for the target entity, and a predicted entity value 207 for the target entity. Multiple target entities can be assigned to a user of a source entity. Alternatively, a target entity may be reassigned to a different user.

In one embodiment, the engagement score 205 can be calculated based on several factors using a predetermined algorithm. An engagement score represents the interactive activities between a source entity and a target entity. For example, the factors may include the number of meetings held in a predetermined period of time in the past such as 30 days, the number of meetings scheduled in a predetermined period of time in future such as the next 30 days, and emails exchanged between the source entity and the target entity. The engagement score is an indicator of efforts that the assigned user has been making with counterpart user(s) of the corresponding target entity. The predicted entity value 207 can be used to rank the list of entities, with the entity on the top (i.e., Walmart) having the largest predicted entity value and the entity at the bottom (i.e., Microsoft) having the smallest predicted entity value.

Other attributes displayed for each account includes an intent buying stage 209, a number of employees 211, a type of industry 213, a total number of meetings 215, a number of upcoming (scheduled) meetings 216, and a number of emails sent 217. The information about the meetings and the emails can be used by supervisors to track the selling efforts of a salesperson.

In one embodiment, the entity management UI 104 allows users to view all entities assigned to them, and also allows other users (e.g., supervisors) to view all entities assigned to users under their supervision. The sum of the predicted entity values of all entities assigned to a user, when multiplied by a conversion coefficient, can be used as the user's entity based transaction quota.

In one embodiment, the UI entity management interface 104 can provide functionality for comparing the entity based quota and the current quota for a user for use in calibrating the entity periodization ML model that generates the predicted entity values.

In one embodiment, the entity management UI 104 may include functionality that enables a user to navigate the entity hierarchy to view entity assignments and move entities around by dragging and dropping. As changes to entity assignments are being made, quotas can be dynamically calculated and adjusted accordingly in real time.

Thus, the entity management UI 104 can provide a set of tools and entity information to optimize entity assignments and transaction quotas. Once the entity assignments and quotas are optimized, the engagement score for each entity and the communication activity (e.g., meetings held and scheduled and emails sent) can be used to track the activities with the entities to ensure that the responsible user is interacting with the entities.

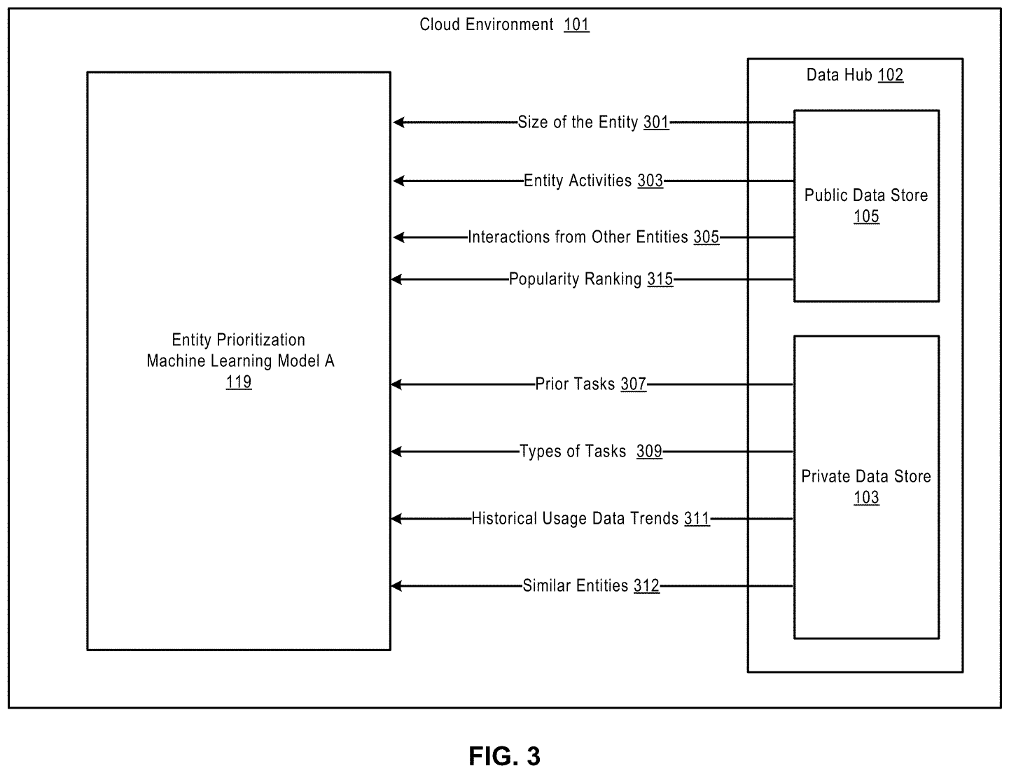

FIG. 3 illustrates input data provided to an entity prioritization machine learning model according to one embodiment. As shown in FIG. 3, the entity prioritization machine learning model A 119 can take a number of features extracted from the data hub 102 as input data. The feature extraction can be performed by the data hub 102 or the entity periodization machine learning model A 119.

For each entity, the features extracted from the public data store 105 can include the size of the entity 301 associated with the entity such as the number of members associated with the entity (e.g., employees). The features may further include amount of activities incurred from the entity 303 such as IT or research and development (R&D) budget of the entity, and activities 305 between the entity and other entities. The features may further include a popularity ranking 315 of the entity provided by a third-party popularity ranking agent such as Alexa ranking agent. The popularity ranking represents how popular an entity is perceived by other entities or users.

The types of products can be classified into different categories and sub-categories. For example, for servers, the technologies purchases can include one or more of Apache Servers, Apache Tomcat, Apple Mac OS, or Nginx; for collaboration applications, the technologies purchases can include one or more of Cisco WebEx, Citrix GoToMeeting, Google G Suite (Google Apps), Box, Dropbox, Smartsheet, Atlassian, or Slack.

For each entity, the features extracted from the private data store 105 can include prior tasks 307 performed by the entity (prior transactions); types of tasks such as a product mix acquired by the entity 309; historical usage data trends such as current license consumption and projected license consumption 311; and similar entities such as competing entity 313. The above features are internal and specific to the entity.

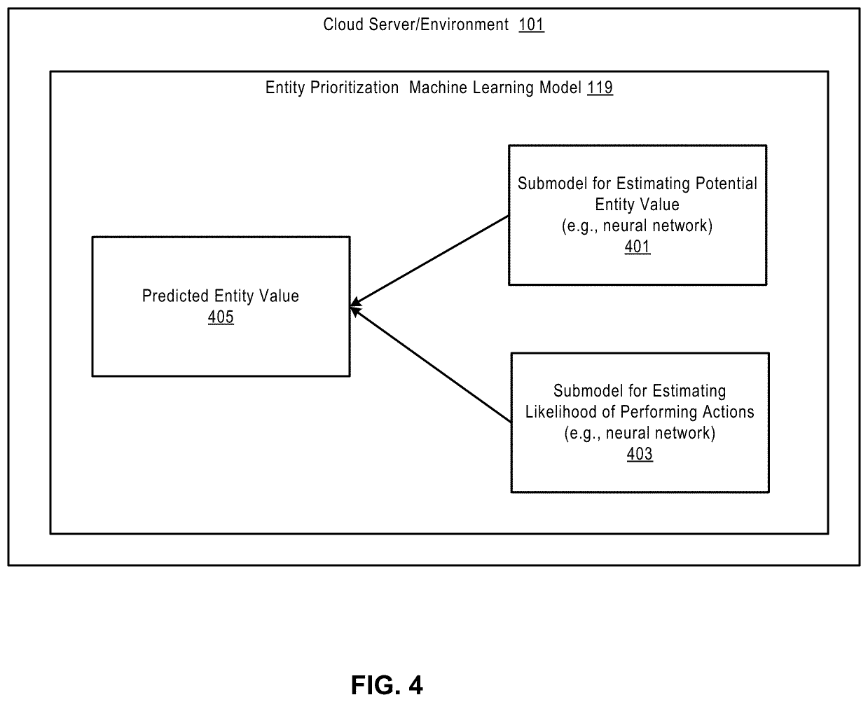

FIG. 4 illustrates an example of a machine learning model for generating predicted entity values according to one embodiment. As described above, the cloud environment 101 is a system that can include servers for training and hosting machine learning models, a data hub for storing public data and private data for training and executing the machine learning models.

A source entity may register with the cloud environment 101. With the registration, a source entity account can be created for the source entity, and data related to the source entity can be uploaded from a task database system. The uploaded data for the source entity may include data for the source entity and data for the target entities associated with the source entity. The target entities associated with a source entity may include the target entities with an existing relationship with the source entity, as well as potential target entities that can potentially create a relationship with the source entity. Further, public firmographic data for each target entity or potential target entity of the source entity can be uploaded to the cloud environment 101 and is automatically synchronized with the firmographic data vendor.

The private data and the public data uploaded to the cloud environment 101 can be used to train machine learning model for each source entity. The machine learning model can generate a predicated entity value for each existing target entity or potential target entity. The predicated entity value can be a measure of the quality of a target entity, and can represent potential activities or transactions to the existing entity or potential entity from the source entity.

The entity prioritization model A 119 can be trained for entity A, and can be used to generate a list of ranked entities for source entity A based on the predicted entity values of the target entities associated with the source entity A. The entity prioritization machine learning model A 119 can include two submodels, which may be implemented as a neural network. The first submodel 401 is used for estimating a potential entity value of each target entity, and the second submodel 403 is used for collaboratively performing a task or a predetermined action with source entity A.

The potential entity value can be a dollar amount that is generated by the submodel 401 based on the extracted features from the public data store 105. The features used by the submodel 401 can be extracted from the public data store 105, and can include the size of the entity, the total IT budget, and transactions from other source entities.

In one embodiment, during the training stage of the submodel 401, all completed tasks in a given period of time (e.g., a year) can be used to determine an amount of transactions performed by the entity. The output of the trained submodel 401, when run on a new set of accounts, can be a predicted entity value for each target entity.

The features used by the submodel 403 can be extracted from the private data store 103. For a net new target entity, the likelihood of performing a transaction or a predetermined action can be calculated in terms of how similar the potential entity looks to other entities that have transactions with the source entity (i.e., entity A) in the past. The features can be extracted from an entity data object in a task database system, and user activities from mail servers or calendars.

The features extracted from the entity data object can include one or more fields of the entity data object. Examples of the fields extracted from the entity data object can include previous tasks, including a type of each task, a size of the task, and an outcome of the task (i.e., completed or incomplete). The user activities can include emails and meetings extracted from a mail server or a calendar. For an existing target entity, the submodel B 403 can determine a likelihood of performing a predetermined action or a task by examining how likely the target entity is to continue interactions from the source entity, for example, acquiring new products and expanding the number of consumption licenses.

In one embodiment, the likelihood of performing an action generated by the submodel 403 can be in a form of a percentage representing a probability. The product of the likelihood of performing an action or task multiplied by the potential entity value for an entity is the predicted entity value 405 of the entity.

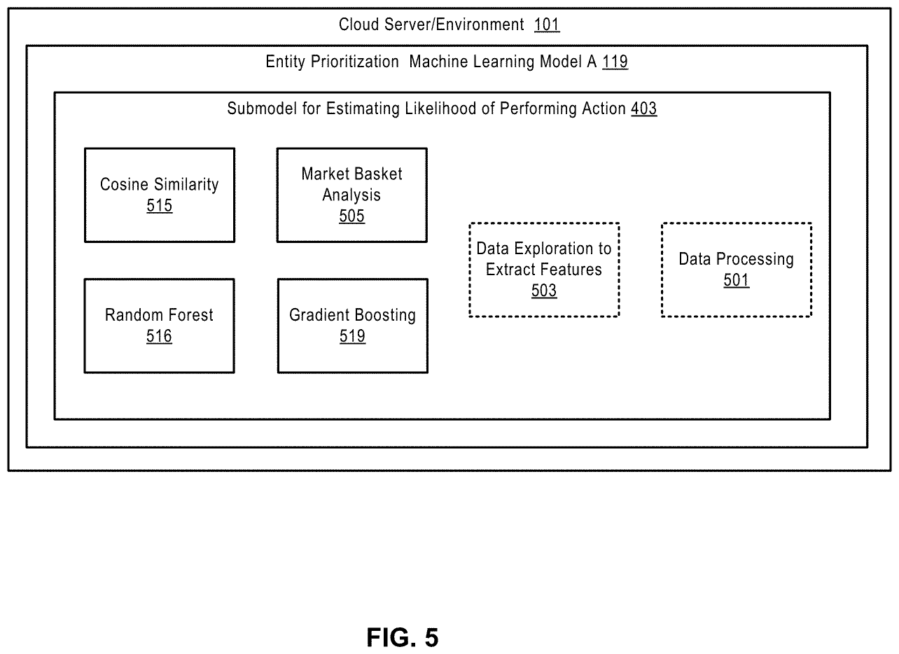

FIG. 5 further illustrates the submodel 403 for estimating the likelihood of performing a task or action according to one embodiment. As shown in FIG. 5, the submodel 403 for estimating the likelihood of performing an action or task for an entity can include a data processing operation 501, a data exploration operation 503 to extract features from the processed data. The submodel 403 further includes a number of machine learning algorithms to determine the similarity between an existing entity and a potential or new entity. The similarity can be used to determine the likelihood of performing an action or task by the potential entity with the source entity.

In one embodiment, the machine learning algorithms can include a market basket analysis 504, a cosine similarity 515, a random forest 516, and a gradient boosting 519. Other machine learning algorithms (not shown) that can be used include a term frequency-inverse document frequency (TFIDF) representation 507, and a decision tree 517. Not all algorithms described above need to be used for the submodel 403. Regardless which algorithms are used, the data processing operation 501 and the feature extraction operation 503 are performed before any of the algorithms is executed.

In one embodiment, in the data processing operation 501, data from different sources are merged, duplicate records are removed, and records without all the desired features are filtered out. In the feature extraction operation 503, a number of features are extracted from the data stores (e.g., the data stores 103 and 105 in FIG. 1), and loaded into a data structure such as an array. These features, as described above, can include a size of the target entity, engagement time, an amount of annual transactions. The engagement time can be a total length of time spent on communicating by a user of the source entity with a target entity (i.e., an existing entity or a new/potential entity).

In one embodiment, the market basket analysis 505 is an algorithm used to identify relationships between the items by examining combinations of the items that occur together frequently in transactions. For example, the market basket analysis algorithm can be used to identify that 100% of the customer accounts who bought Window servers also bought Unix. This relationship can be useful in predicting what other products the customer may purchase based on one or more products that the customer has already purchased.

The cosine similarity 515 is another algorithm or technique used by the submodel 403 to estimate how likely that an entity is to perform a transaction with another entity. Instead of simply comparing transactions between an entity and a new entity, the cosine similarity compares a new entity with an existing entity in terms of the technologies used.

The random forest algorithm 416 is a supervised machine learning algorithm used to build multiple decisions trees and merge them together to get a more accurate and stable prediction of the entity value.

The gradient boosting 519 is a machine learning technique for regression and classification problems, which produces a prediction model in the form of an ensemble of weak prediction models, e.g., decision trees. The gradient boosting 519 can build the prediction model in a stage-wise fashion, and generalize them by allowing optimization of an arbitrary differentiable loss function.

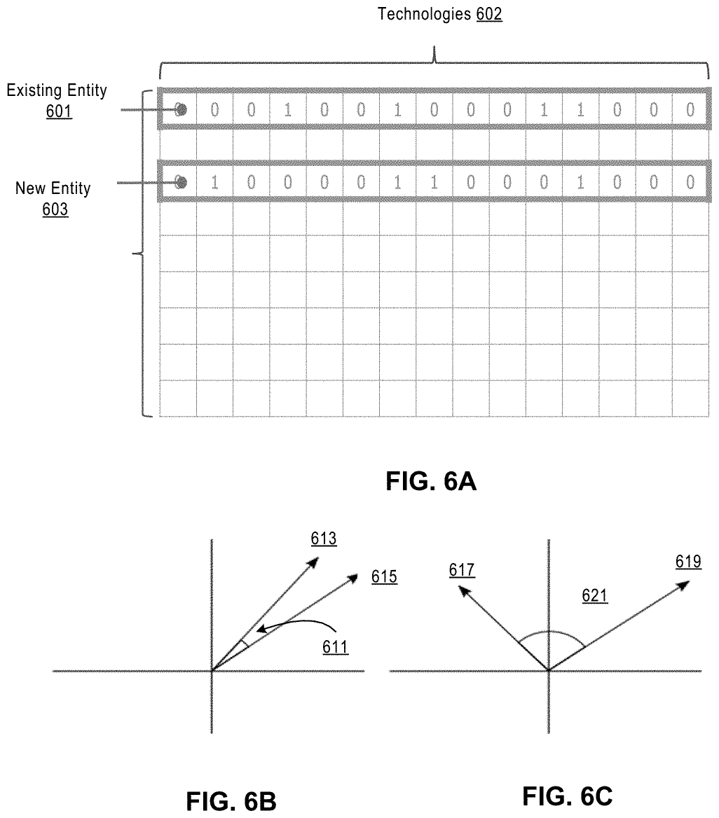

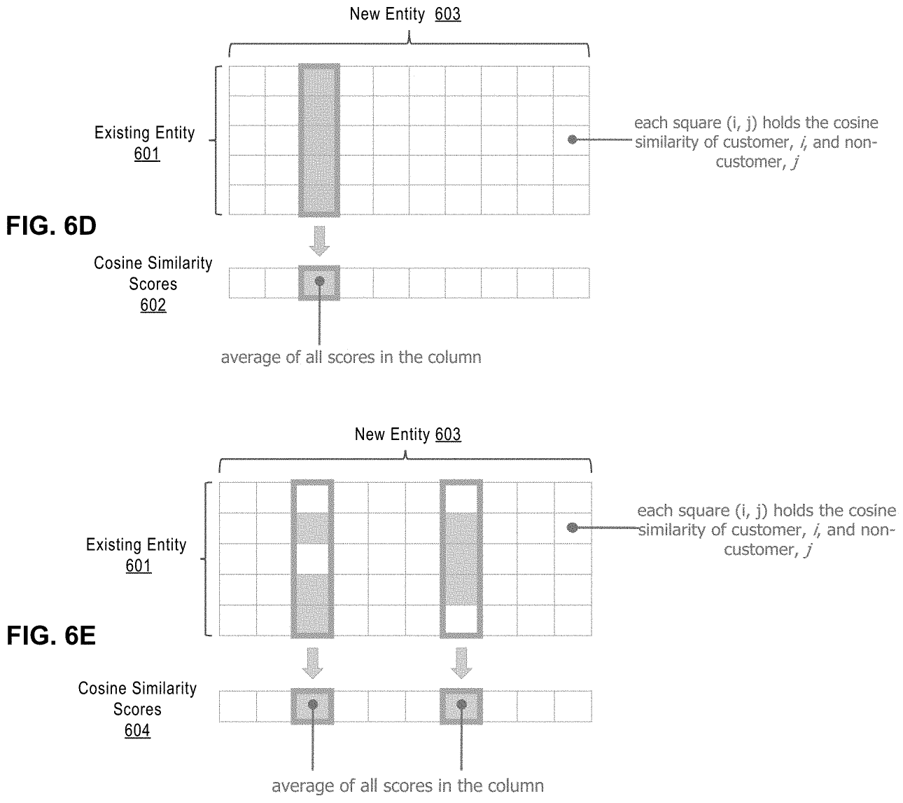

FIGS. 6A-6C illustrate a cosine similarity algorithm according to one embodiment. FIG. 6A shows a matrix, where the rows show entities including existing entity (e.g., entity 601) or new entity (e.g., entity 603), the columns 602 show all technologies across all entities, and the values are one-hot encoding values, with 1 representing the use of that technology by the entity, and 0 representing the non-use of the technology by the entity.

In one embodiment, a different way of encoding the values in the matrix can be used. For example, a term frequency-inverse document frequency (TFIDF) can be used to reduce the weight of technologies that occur very frequently in the entities and increase the weight of technologies that occur rarely.

Each row can be treated as a geometric vector where the row is regarded as a point in space that has d dimensions 609, where d equals to the number of technologies. The vector can start at an origin, which is a d dimensions point (0, 0, . . . , 0); and can end at a point in space represented by values (i.e., coordinates) in the row. As such, the magnitude of the vector indicates how many technologies are used by the entity, and the direction of the vector indicates which technologies are used by the entity.

FIG. 6B shows a cosine of an angle 611 between vectors 613 and 615 in the same direction. The angle 611 is close to 0 degree and therefore the cosine of the angle 611 is close to 1, i.e. 100%. FIG. 6C shows a cosine of an angle 621 between vectors 617 and 619 that are nearly orthogonal. The angle 621 is close to 90 degrees, and therefore the cosine of the angle 621 is near 0, i.e. 0%. Therefore, the vectors 613 and 615 are very similar while the vectors 617 and 619 are very different.

Thus, using the cosine similarity algorithm, a new or potential entity that looks similar to an existing entity can be found in terms of their technological profiles. The similarity between two vectors can be represented by a cosine similarity score.

FIGS. 6D-6F illustrates different ways of computing the cosine similarity scores for each new entity according to one embodiment. FIGS. 6D-6F tabulate the cosine similarity scores between each entity of the entity 601 and each of the new entity 603. Each square (i,j) in the figures holds the cosine similarity score between an existing entity and a new entity.

FIG. 6D represents a method of computing similarity scores for ranking the potential entity for the data-encoding method described in FIG. 6A. According to this method, all the similarity scores in a column are averaged. The average scores 602 of the columns are then ranked to obtain rankings of potential entities based on their similarity scores.

FIG. 6E represents a method of computing similarity scores for ranking the potential entities for the TFIDF data encoding method. When data is encoded this way, there can be clusters of entities in terms of types of technological profiles. According to this method of computing the similarity scores for ranking the potential entities, only the top three scores in each column are averaged. The number of 3 is used for the purpose of illustration. A user can use a different number, for example, 5 or 8. The potential entities can then be ranked based on the averaged similarity scores 604.

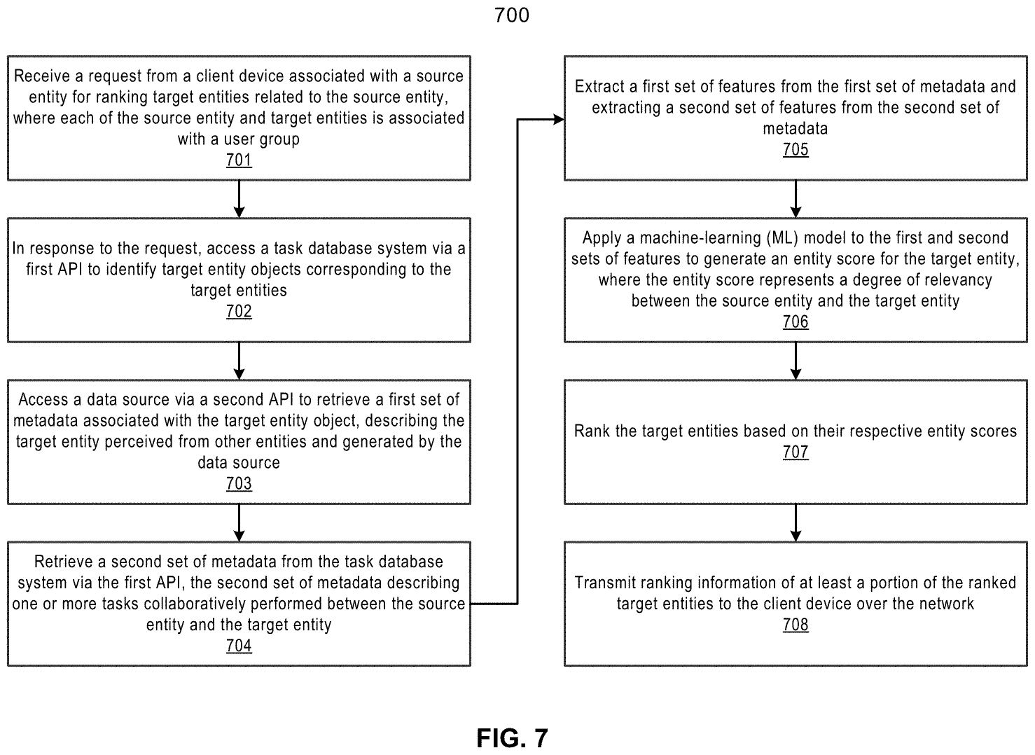

FIG. 7 is a flow diagram illustrating an example of a process 700 of classifying entities according to one embodiment. Process 700 may be performed by processing logic which may include software, hardware, or a combination thereof. For example, process 700 may be performed by the data hub 102 and the machine learning models 119, 121 and 123 as illustrated in FIG. 1. Referring to FIG. 7, at block 701, processing logic receives a request from a client device associated with a source entity for ranking target entities related to the source entity. Each of the source entity and target entities is associated with a user group, a company, or a unit or department of a company. At block 702, in response to the request, a task database system is accessed via a first API to identify target entity objects corresponding to the target entities. At block 703, a data source is accessed via a second API to retrieve a first set of metadata or attributes associated with the target entity object. The first set of metadata describes the target entity perceived from other entities and generated by the data source.

At block 704, a second set of metadata is retrieved from the task database system via the first API, where the second set of metadata describes one or more tasks collaboratively performed between the source entity and the target entity. At block 705, a first set of features is extracted from the first set of metadata and a second set of features is extracted from the second set of metadata. At block 706, a machine-learning (ML) model is applied to the first and second sets of features to generate an entity score for the target entity. The entity score represents a degree of relevancy between the source entity and the target entity. For example, the entity score of a target entity represents an importance or how valuable of the target entity with respect to a source entity. At block 707, the target entities are ranked based on their respective entity scores. At block 708, ranking information of at least a portion of the ranked target entities is transmitted to the client device over the network.

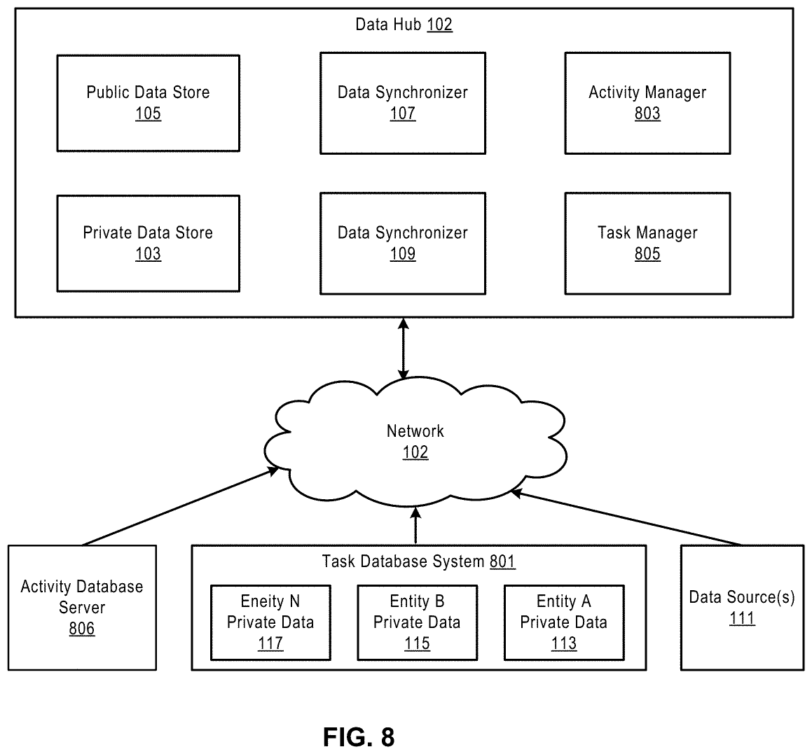

FIG. 8 further illustrates the data hub 102 according to one embodiment. As shown, the data hub 102 can further include an activity manager 803, and a task manager 805. The task manager 805 is configured to interact with the task database system 801 to access and manage tasks hosted by task database system 801. The activity manager 803 is configured to determine any activities associated with a particular task, such as emails and calendar events.

In one embodiment, the activity manager 803 is configured to identify activities of a task associated with a user by invoking the task manager 805, which communicates with the task database system 801 to determine target email addresses of a prospect customer or an existing customer. The activity manager 803 also determines source email addresses of users associated with the task. For the source email addresses and target email addresses, the activity manager 803 can automatically query the activity database server 806 to determine email and meeting activities associated with the task. The activity manager 803 can automatically populate these activities as soon as meetings have been scheduled and/or emails have been exchanged at the activity database server 806.

The task manager 805 may query the task database system 801 to obtain a list of tasks that are associated with a particular entity (e.g., a user, a group of users, and a customer). The task database 801 can be associated with or utilized by a user that works as a sales representative.

For example, a team manager of a sales team having one or more team members can log into the task database system 801, and in response to the login, the task manager 805 can communicate with task database system 801 to retrieve a list of tasks assigned to one or more of the team members.

In one embodiment, when the task manager 805 queries task database system 801, the task manager 805 can send a query request to task database system 801. The query request can include a number of parameters that specify one or more attributes of the tasks to be queried and retrieved. In response to the query request, task database system 801 operates to return the list of tasks. For example, the task manager 805 can query task database system 801 by specifying that only account contacts of a particular account should be retrieved or only contacts of a particular task should be retrieved. Alternatively, task database system 801 may perform filtering of accounts and/or tasks to identify the tasks.

In one embodiment, the two data synchronizers 107 and 109 can periodically retrieve activity data from the activity server 806 via a first processing thread. The data collection thread may be executed during the time period in which the activity server 806 is not busy (e.g., at night). A second processing thread is periodically executed in which the activity manager 803 is configured to parse and analyze activity. The first processing thread and the second processing thread may be running independently at different points in time or concurrently during the same period of time. In one embodiment, the activity data includes one or more event objects containing data of certain events. An event can be an email, a calendar event (e.g., a meeting), a chat group (e.g., instant messaging, wechat), etc.

For each of the event objects found in the activity data, the activity manager 803 determines participant IDs identifying the participants of the corresponding event. A participant ID can be an email address, a chat ID, and/or a mobile phone number of a participant. For each of the participant IDs, the activity manager 803 determines or extracts a domain ID identifying a domain associated with the corresponding participant.

For each domain ID, the task manager 805 searches and identifies one or more account objects from the task database system 801. Typically, a domain ID is associated with a specific corporate or enterprise client and each client may have one or more entities (e.g., corporate divisions or accounts). For example, a domain name is typically associated with an account object.

Each account object may further be associated with one or more user objects corresponding to one or more users associated with the account object (e.g., entity level users). A user object may contain user information of a particular user such as contact information of the user (e.g., name, phone number, email address, and/or chat ID). Each account object may further be associated with one or more task objects such as task objects. Each task object contains information or metadata describing a particular task such as a project, an opportunity, or a deal. Each task object may further be associated with one or more user objects such as user objects. The user objects contain user information of users that are a part of a user group associated with a specific task or tasks. A user object may be associated with one or more task objects. A user object may also be associated with one or more account objects.

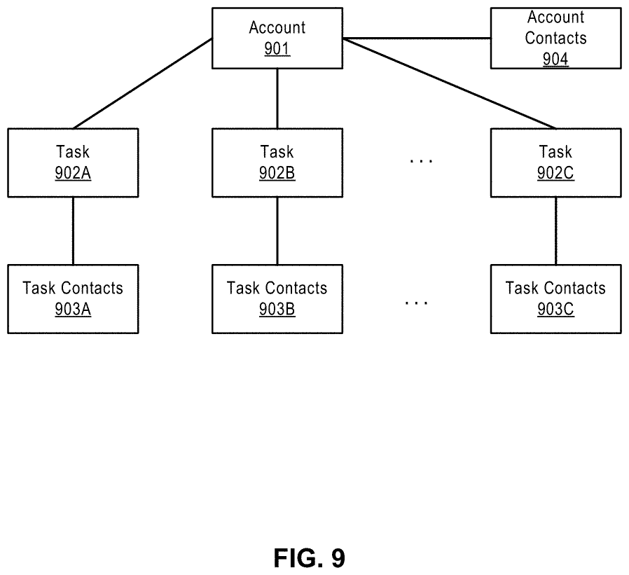

FIG. 9 illustrates an example of an account object according to one embodiment. As shown in FIG. 9, an account object 901 may be associated with one or more tasks 902A-902C. A task is a deal, project or an opportunity.

For example, the account 901 may belong to a sales company that has potential tasks 902A-902C being concurrently processed. The account 901 may be managed by one or more persons at an account level, referred to as account contacts 904. Each of the tasks 902A-902C may be managed by one or more persons at a task level, referred to herein as tasks contacts, such as task contacts 903A-903C. Different people may be associated with account contacts 904 and task contacts 903A-903C. Alternatively, a single person can be a part of both account contacts 904 and any one or more of task contacts 903A-903C. Each of account contacts 904 and task contacts 903A-903C may include one or more email addresses of the contact and/or a Web site associated with the account or task. This contact information may be stored in the task database system 801 and can be accessible via queries.

For each of the tasks (e.g., tasks 902A-902C of FIG. 9), the task manager 805 can query the task database system 801 to obtain a first list of one or more target contacts associated with the task (e.g., task object). For the target contacts in the first list, the activity manager 803 can determine a domain name based on contact information of the contacts (e.g., emails, Web addresses, name of an account associated with the contacts). A first set of email addresses, referred to as target email addresses, can be determined based on the domain name and target contacts using a set of activity identification rules. An email server (e.g., implemented as part of the activity server 806) can be queried to retrieve a list of one or more emails based on the first set of email addresses.

In one embodiment, in this disclosure, each task in the task database system 801 can be associated with a source contact and one more target contacts. A source contact refers to a person that is responsible for the task within a sales organization. An example source contact is a sales representative that works on a task. As such, a source contact in this disclosure can be used interchangeably with a user. A target contact can be an outside party; for example, a person that a user needs to work with when completing a task. In one embodiment, a target contact can be a point of contact on the side of a customer associated with a particular task.

In one embodiment, in determining the email address of a target contact associated with a task, if the target contact includes an email address of the target contact, the email address would be directly used in identifying the activities (e.g., email communication). The domain name can be extracted from the email address can be used to identify email addresses of other target contacts associated with task. However, in some situations, the target contact information stored in the task database system 801 may not include an email address of the target contact. In such a scenario, the domain name can be derived from other information (e.g., name, notes, Web address, phone number, social network such as Facebook®, Twitter®, LinkedIn®, etc.) associated with the target contact.

The activity identification rules may specify a preference or priority order indicating which of the contact information should be used in order to identify a domain name. For example, activity identification rules may specify that a target contact should be used to determine a domain name over the account contact, and that the account contact will be used only if the target contact is unavailable.

In one embodiment, in determining a domain name for a customer, the activity manager 803 first determines whether there is any target contact associated with a task under a corresponding account for the customer. If there is, the activity manager 803 can determine the domain name based on the target contact; if there is not, the activity manager 803 determines the domain name based on an account contact associated with the account to which the task belongs. The domain name may be obtained from an email address or other information of the account contact. In this example, the activity identification rules associated with this task may specify that a task contact should be utilized over an account contact in determining a domain name.

In one embodiment, if there is no account contact associated with the account of the task, the activity manager 803, depending on the activity identification rules, may determine the domain name based on a Web address of a Web site associated with the account. The Web address may also be obtained from the task database system 801 as a part of account contact information of the account associated with the task.

According to one embodiment, if there is no Web address obtained from the task database system 801, the activity manager 803 determines the domain name from a domain name registry, such as domain name registry, based on an account name of the account.

If there is no registered domain name based on the account name, the activity manager 803 utilizes a name-to-domain (name/domain) mapping table to obtain the domain name based on the account name. In one embodiment, name/domain mapping table includes a number of mapping entries, where each mapping entry maps a particular name to a domain name. Name/domain mapping table may be maintained and updated over time to map a name to a domain name, especially when a name is not related to a domain name from its appearance.

In one embodiment, the activity manager 803 further determines a second list of one or more source contacts associated with each task via the task manager 805 from the task database system. The second list of source contacts are contacts for one or more team members of a sales team that work with one or more target contacts for the task. A source contact can be an owner of the task, a sales representative, and/or an account representative. A second set of email addresses associated with the source contacts of the second list can be determined by the activity manager 805, where the email addresses of the second list are referred to as source email addresses.

In one embodiment, after obtaining the first set of email addresses and the second set of email addresses, the activity database server 806 can be queried based on the source email addresses and the target email addresses to obtain a list of emails that have been exchanged between the source email addresses and the target email addresses (e.g., senders and recipients).

In one embodiment, only email exchanged between the source email addresses and the target email addresses associated with the same task are to be retrieved. In some situations, a source contact may need to handle multiple tasks of different accounts and/or different customers. Similarly, a target contact may handle multiple tasks of an account or multiple accounts. The activity manager 803 can retrieve emails pertinent to a same task can by matching the exact source email addresses and target email addresses for the same task.

In one embodiment, if emails are exchanged prior to the creation of the task, such emails can be removed from the list of emails, snice the emails are not unlikely related to the task. In addition, contacts for a broker or a product reseller or a distributor would not be utilized in determining the domain name for the purpose of identifying emails of the task.

For example, if a particular contact is associated with more than a predetermined number of accounts (e.g., five accounts), such a contact is deemed to be a broker or reseller or distributor and is deemed not to be a proper target contact or source target. Similarly, if a task has been closed, the task would be removed and the emails associated with the task would not be retrieved.

As described above, an entity can be a user group, an organization, or a unit or department of an organization. A source entity refers to an entity that provides services or goods to another entity (e.g., a target entity). A target entity refers to an entity that receives or acquire services or goods from another entity (e.g., a source entity). For example, a source entity can be seller entity and a target entity can be a buyer entity. A task database system can be a customer relationship management system. A task refers to an action performed by a source entity and/or a target entity. For example, a task can be a process of negotiating an agreement between a source entity and a target entity such as an agreement for a target entity to acquire services or goods from a source entity. The ML modes described above can be used to determine or predict the value or asset of a target entity from a source entity point of view based on the public data of the target entity that is obtained from various third-party data sources and the private data representing prior interactions between the target entity and the source entity, which may be obtained from the task database system. The ML models can further determine the likelihood that the target entity will acquire more services or goods from the source entity within a time period.

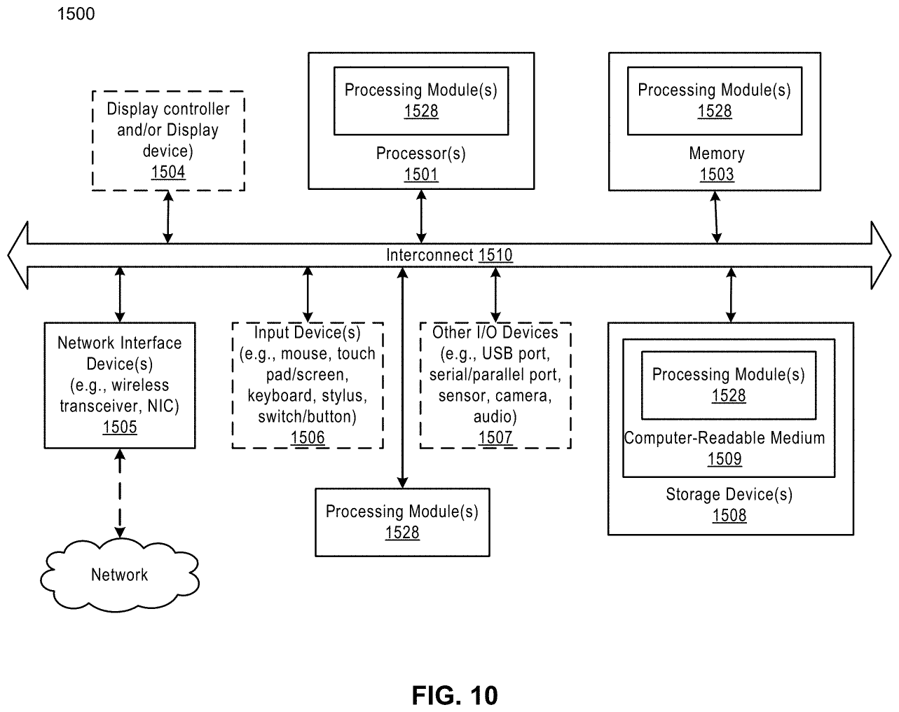

FIG. 10 is a block diagram illustrating an example of a data processing system which may be used with one or more embodiments of the invention. For example, system 1500 may represent any of data processing systems described above performing any of the processes of methods described above, such as, for example, client devices 101-102 and servers 105-107 and 111 of FIG. 1. System 1500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

Note also that system 1500 is intended to show a high level view of many components of the computer system. However, it is to be understood that additional components may be present in certain implementations and furthermore, different arrangement of the components shown may occur in other implementations. System 1500 may represent a desktop, a laptop, a tablet, a server, a mobile phone, a media player, a personal digital assistant (PDA), a Smartwatch, a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 1500 includes processor 1501, memory 1503, and devices 1505-1508 via a bus or an interconnect 1510. Processor 1501 may represent a single processor or multiple processors with a single processor core or multiple processor cores included therein. Processor 1501 may represent one or more general-purpose processors such as a microprocessor, a central processing unit (CPU), or the like. More particularly, processor 1501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 1501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 1501, which may be a low power multi-core processor socket such as an ultra-low voltage processor, may act as a main processing unit and central hub for communication with the various components of the system. Such processor can be implemented as a system on chip (SoC). Processor 1501 is configured to execute instructions for performing the operations and steps discussed herein. System 1500 may further include a graphics interface that communicates with optional graphics subsystem 1504, which may include a display controller, a graphics processor, and/or a display device.

Processor 1501 may communicate with memory 1503, which in one embodiment can be implemented via multiple memory devices to provide for a given amount of system memory. Memory 1503 may include one or more volatile storage (or memory) devices such as random access memory (RAM), dynamic RAM (DRAM), synchronous DRAM (SDRAM), static RAM (SRAM), or other types of storage devices. Memory 1503 may store information including sequences of instructions that are executed by processor 1501, or any other device. For example, executable code and/or data of a variety of operating systems, device drivers, firmware (e.g., input output basic system or BIOS), and/or applications can be loaded in memory 1503 and executed by processor 1501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 1500 may further include 10 devices such as devices 1505-1508, including network interface device(s) 1505, optional input device(s) 1506, and other optional IO device(s) 1507. Network interface device 1505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 1506 may include a mouse, a touch pad, a touch sensitive screen (which may be integrated with display device 1504), a pointer device such as a stylus, and/or a keyboard (e.g., physical keyboard or a virtual keyboard displayed as part of a touch sensitive screen). For example, input device 1506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 1507 may include an audio device. An audio device may include a speaker and/or a microphone to facilitate voice-enabled functions, such as voice recognition, voice replication, digital recording, and/or telephony functions. Other IO devices 1507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 1507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1510 via a sensor hub (not shown), while other devices such as a keyboard or thermal sensor may be controlled by an embedded controller (not shown), dependent upon the specific configuration or design of system 1500.

To provide for persistent storage of information such as data, applications, one or more operating systems and so forth, a mass storage (not shown) may also couple to processor 1501. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 1501, e.g., via a serial peripheral interface (SPI). This flash device may provide for non-volatile storage of system software, including a basic input/output software (BIOS) as well as other firmware of the system.

Storage device 1508 may include computer-accessible storage medium 1509 (also known as a machine-readable storage medium or a computer-readable medium) on which is stored one or more sets of instructions or software (e.g., module, unit, and/or logic 1528) embodying any one or more of the methodologies or functions described herein. Processing module/unit/logic 1528 may represent any of the components described above, such as, for example, task manager 210, activity manager 220, and the pending activity reminder module 121, as described above. Processing module/unit/logic 1528 may also reside, completely or at least partially, within memory 1503 and/or within processor 1501 during execution thereof by data processing system 1500, memory 1503 and processor 1501 also constituting machine-accessible storage media. Processing module/unit/logic 1528 may further be transmitted or received over a network via network interface device 1505.

Computer-readable storage medium 1509 may also be used to store the some software functionalities described above persistently. While computer-readable storage medium 1509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Processing module/unit/logic 1528, components and other features described herein can be implemented as discrete hardware components or integrated in the functionality of hardware components such as ASICS, FPGAs, DSPs or similar devices. In addition, processing module/unit/logic 1528 can be implemented as firmware or functional circuitry within hardware devices. Further, processing module/unit/logic 1528 can be implemented in any combination hardware devices and software components.

Note that while system 1500 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method of ranking entity objects, the method comprising:
receiving, at a cloud server over a network, a request from a client device associated with a source entity for ranking target entities related to the source entity, wherein each of the source entity and target entities is associated with a user group;
in response to the request, accessing a task database system via a first application programming interface (API) to identify a plurality of target entity objects corresponding to the target entities;
for each of the target entity objects,
accessing a data source via a second API to retrieve a first set of metadata associated with the target entity object, the first set of metadata describing the target entity perceived from other entities and generated by the data source,
retrieving a second set of metadata from the task database system via the first API, the second set of metadata describing one or more tasks collaboratively performed between the source entity and the target entity,
extracting a first set of features from the first set of metadata and extracting a second set of features from the second set of metadata, and
applying a machine-learning (ML) model to the first set of features and the second set of features to generate an entity score for the target entity, wherein the entity score represents a degree of relevancy between the source entity and the target entity;
ranking the plurality of target entities based on their respective entity scores; and
transmitting ranking information of at least a portion of the ranked target entities to the client device over the network.

2. The method of claim 1, wherein applying the ML model to the first and second sets of features comprises applying a first neural network to the first and second sets of features to determine a first score representing a degree of how valuable of the target entity perceived by the source entity, wherein the entity score is determined based on the first score.

3. The method of claim 2, further comprising:
applying a second neural network to the first and second sets of features to determine a second score representing a likelihood the target entity will perform a task collaboratively with the source entity within a predetermined time period; and
generating the entity score for the target entity based on the first score and the second score using a predetermined algorithm.

4. The method of claim 1, further comprising:
selecting a predetermined number of top-ranked target entities based on their respective entity scores; and
transmitting the ranking information of the top-ranked entities to the client device to be displayed in a graphical user interface (GUI) of the client device.

5. The method of claim 1, wherein the data source includes at least one of a public firmographic database, a popularity ranking database, or a user satisfaction ranking database.

6. The method of claim 1, wherein the first set of metadata of a target entity includes at least one of a number of users within a corresponding user group of the target entity, resources used by the user group, or interactions with other entities.

7. The method of claim 1, wherein the second set of metadata of a target entity includes at least one of one or more prior tasks completed between the source entity and the target entity, types of the tasks completed, or subsequent activities of the prior completed tasks performed between the source entity and the target entity.

8. The method of claim 1, wherein the second neural network uses one or more ML algorithms, including a market basket analysis, a term frequency-inverse document frequency (TFIDF) representation, cosine similarity, decision tree, random forest, or a gradient boosting.

9. The method of claim 1, wherein the entity score is calculated based on a product of the first score and the second score.

10. A non-transitory machine-readable medium having instructions stored therein for identifying target accounts, the instructions, when executed by a processor, causing the processor to perform operations, the operations comprising:
receiving, at a cloud server over a network, a request from a client device associated with a source entity for ranking target entities related to the source entity, wherein each of the source entity and target entities is associated with a user group;
in response to the request, accessing a task database system via a first application programming interface (API) to identify a plurality of target entity objects corresponding to the target entities;
for each of the target entity objects,
accessing a data source via a second API to retrieve a first set of metadata associated with the target entity object, the first set of metadata describing the target entity perceived from other entities and generated by the data source,
retrieving a second set of metadata from the task database system via the first API, the second set of metadata describing one or more tasks collaboratively performed between the source entity and the target entity,
extracting a first set of features from the first set of metadata and extracting a second set of features from the second set of metadata, and
applying a machine-learning (ML) model to the first set of features and the second set of features to generate an entity score for the target entity, wherein the entity score represents a degree of relevancy between the source entity and the target entity;
ranking the plurality of target entities based on their respective entity scores; and
transmitting ranking information of at least a portion of the ranked target entities to the client device over the network.

11. The machine-readable medium of claim 10, wherein applying the ML model to the first and second sets of features comprises applying a first neural network to the first and second sets of features to determine a first score representing a degree of how valuable of the target entity perceived by the source entity, wherein the entity score is determined based on the first score.

12. The machine-readable medium of claim 11, wherein the operations further comprise:
applying a second neural network to the first and second sets of features to determine a second score representing a likelihood the target entity will perform a task collaboratively with the source entity within a predetermined time period; and
generating the entity score for the target entity based on the first score and the second score using a predetermined algorithm.

13. The machine-readable medium of claim 10, wherein the operations further comprise:
selecting a predetermined number of top-ranked target entities based on their respective entity scores; and
transmitting the ranking information of the top-ranked entities to the client device to be displayed in a graphical user interface (GUI) of the client device.

14. The machine-readable medium of claim 10, wherein the data source includes at least one of a public firmographic database, a popularity ranking database, or a user satisfaction ranking database.

15. The machine-readable medium of claim 10, wherein the first set of metadata of a target entity includes at least one of a number of users within a corresponding user group of the target entity, resources used by the user group, or interactions with other entities.

16. The machine-readable medium of claim 10, wherein the second set of metadata of a target entity includes at least one of one or more prior tasks completed between the source entity and the target entity, types of the tasks completed, or subsequent activities of the prior completed tasks performed between the source entity and the target entity.

17. The machine-readable medium of claim 10, wherein the second neural network uses one or more ML algorithms, including a market basket analysis, a term frequency-inverse document frequency (TFIDF) representation, cosine similarity, decision tree, random forest, or a gradient boosting.

18. The machine-readable medium of claim 10, wherein the entity score is calculated based on a product of the first score and the second score.

19. A data processing system, comprising:
a processor; and
a memory coupled to the processor to store instructions for identifying target accounts, the instructions, which when executed by the processor, causing the processor to perform operations, the operations comprising:
receiving, at a cloud server over a network, a request from a client device associated with a source entity for ranking target entities related to the source entity, wherein each of the source entity and target entities is associated with a user group;
in response to the request, accessing a task database system via a first application programming interface (API) to identify a plurality of target entity objects corresponding to the target entities;
for each of the target entity objects,
accessing a data source via a second API to retrieve a first set of metadata associated with the target entity object, the first set of metadata describing the target entity perceived from other entities and generated by the data source,
retrieving a second set of metadata from the task database system via the first API, the second set of metadata describing one or more tasks collaboratively performed between the source entity and the target entity,
extracting a first set of features from the first set of metadata and extracting a second set of features from the second set of metadata, and
applying a machine-learning (ML) model to the first set of features and the second set of features to generate an entity score for the target entity, wherein the entity score represents a degree of relevancy between the source entity and the target entity;
ranking the plurality of target entities based on their respective entity scores; and
transmitting ranking information of at least a portion of the ranked target entities to the client device over the network.

20. The system of claim 19, wherein applying the ML model to the first and second sets of features comprises applying a first neural network to the first and second sets of features to determine a first score representing a degree of how valuable of the target entity perceived by the source entity, wherein the entity score is determined based on the first score.
